(19) United States
(12) Patent Application Publication
(10) Pub. No.: US 2008/0061097 A1
(43) Pub. Date: Mar. 13, 2008

(54) Vehicle Attachment

(76) Inventors: Curt Milender, Folson, CA (US); Charles Rogers, Rapid City, SD (US)

Correspondence Address: GREENBERG & LIEBERMAN, LLC, 2141 WISCONSIN AVE, N.W., SUITE C-2, WASHINGTON, DC, 20007, US

(21) Appl. No.: 11/531,528

(22) Filed: Sep. 13, 2006

(51) Int. Cl. B60R 9/00; B60R 11/00

(52) U.S. Cl. 224/519; 224/524

(57) ABSTRACT

A vehicle attachment that sits behind a vehicle and attaches to the vehicle's trailer hitch. To the plate is attached a device such as a barbecue, tool, etc. The plate is attached to a series of tubular members that connect to one another and ultimately to the vehicle's trailer hitch. The plate is easily removed, allowing the user to either use the plate or to easily attach other attachments to the hollow pole. Therefore, the user can quickly and easily perform a variety of activities at variable heights behind the vehicle.

### FIELD OF THE INVENTION

The present invention is concerned with vehicles with a trailer hitch; and more specifically, the present invention is a vehicle attachment that provides a simple means of attachment for various purposes.

### BACKGROUND OF THE INVENTION

Many vehicles have trailer hitches, especially pickup trucks. Trailer hitches are designed to do exactly what their name implies—serve as a hitch for attaching trailers. However, over the years, people have found that the simple trailer hitch is a standard interface for a variety of devices aside from just trailers.

When camping, tailgating, or simply working in the driveway, having a trailer hitch means that the user has a plethora of options for extending the usability of a vehicle. For example, devices have been designed to attach to trailer hitches for use as work tables. In short, such devices have one end mounted to a vehicle via the vehicle's trailer hitch, and then a conventional work table is provided at a second end. Whether a vice is added or any other tool, the concept remains the same: one end attaches to a trailer hitch and the other end provides a surface for the user to carry out a desired activity. Unfortunately, such devices are typically very heavy because they need to withstand the weight of the items affixed atop them. For example, if a barbecue is affixed atop a table attached to a trailer hitch, then the weight of the barbecue needs to be fully supported by the table that is attached to the trailer hitch. Thus, the table that is attached to the trailer hitch is typically heavy, not easily maneuverable and managed by all but the strongest of individuals. Furthermore, the supporting structure under the table is typically of heavy gauge steel so that that weight can be supported. Again, the supporting structure is oftentimes too heavy to lift and attach to a trailer hitch by all but the strongest individuals.

U.S. Pat. No. 6,935,656 issued to Stout on Aug. 30, 2005, shows a combination hitch-mountable utility cart. In short, Stout's device is a utility-cart that mounts to the hitch of a vehicle. It features a lever-operated load lift assembly that adjusts the elevation of the load-carrying platform. It also may be locked into position. Stout's device is useful for attaching to the trailer hitch of a vehicle, but does not present versatility beyond that of a support frame for a payload. One undesirable feature of Stout's device is that it uses a lever to adjust height, which is not the simplest of designs. Further, Stout's device provides for not just a vertical motion, but also has horizontal motion as it swings, and this is undesirable. A purely vertical adjustment scheme, which Stout's device does not have, is desirable for fine tuning height without the worry that you might disturb the horizontal position of the device.

U.S. Pat. No. 6,976,820 issued to Sandy on Dec. 20, 2005, describes a bed extension and stepgate pickup truck apparatus. In short, Sandy's invention is a pickup truck bed extension platform that extends outward from the truck horizontally. It also moves vertically and allows items to be lifted into the truck using the truck's tailgate. Sandy's invention is required to attach underneath the truck to the truck's frame. Also, Sandy's vertical adjustment mechanism appears rather complex because it employs a piston to raise and lower a platform.

U.S. Pat. No. 6,082,269, issued to Padberg on Jul. 4, 2000, shows a hitch-mountable accessory that resembles a table an umbrella. Padberg's device has a base member with a horizontal component that engages a hitch receiver tube of a hitch, and it also has an upwardly extending vertical component. A table and/or umbrella may be supported directly on the vertical component, and a second table may be mounted so that it can rotate. There is no means provided for adjusting height and no means for enabling secure holding of a lightweight assembly. Essentially, Padberg's device is simply limited to its intended table and umbrella offering; Padberg's device cannot be easily adapted for different uses if the table and umbrella are not desired.

U.S. Pat. No. 5,678,743 issued to Johnson et al. on Oct. 21, 1997, describes a truck bed extender that engages a trailer hitch at one end and then has an elongated support bar and rack. The rack has a horizontal cross bar that adjust vertically on the support bar at a second end. Much like Padberg's device, there is no provision for various applications aside from acting as a horizontal cross bar.

U.S. Pat. No. 5,267,748 issued to Curran on Dec. 7, 1993, shows a vehicle tool platform apparatus and method. Curran's invention has a flat tool platform, and elongated angle support bar that has one end secured to the bottom surface of the tool platform and the other end adapted to be received and secured in the rear trailer hitch. A work tool such as a vise, bench grinder, or saw is secured to the top surface of the tool platform. The plane of the tool platform is generally level with the floor of the van or the bed of the truck to which Curran's invention is secured. Additionally, the platform is positioned a sufficient distance from the rear of the vehicle to permit the doors of the vehicle to be opened fully, or the tailgate of the truck to be lowered to a plane level with and adjacent to the top surface of the work platform apparatus. Unfortunately, the platform of Curran's invention is just that, a platform to which tools can be attached via conventional means. Curran's invention does not offer much flexibility beyond tools. Curran's invention is also not terribly adjustable to various heights.

There is a need for a vehicle attachment that is capable of moving up and down (vertically) while avoiding disturbing its horizontal displacement. Further, there is a need for a vehicle attachment that is capable of securing easily to the trailer hitch on many vehicles. Also, there is a need for a vehicle attachment that provides a point of activity distanced far enough from the tailgate of a pickup truck so that the tailgate can be lowered without interfering with the vehicle attachment. Moreover, there is a need for a vehicle attachment that does not merely serve a single function—such as only existing as a platform for tools, or such as only existing as an umbrella and tables. Further, there is a need for a vehicle attachment that is lightweight yet sturdy.

### SUMMARY OF THE INVENTION

Providing a versatile platform positioned behind a vehicle, the present invention attaches to a vehicle's trailer hitch and then is adjustable in terms of height. As the height of the present invention adjusts, so does its distance from the vehicle's trailer hitch. Further, various accessories attach to the platform of the present invention seamlessly. The present invention is preferably made of aluminum, which makes it comparatively lightweight in light of similar devices. Making the present invention out of aluminum is not simply an obvious choice of materials, however. The present invention is specifically designed to provide biased support so that although the present invention can be made of aluminum, the present invention will not bend and/or break under the weight of anything placed atop it. The present invention is sturdy and has its parts arranged so as to prevent movement and bending. Thus, the present invention functions as well or better than similar devices, but has an arrangement to provide stability because it is lightweight. This arrangement is a combination of bars and sleeves, wherein at least one of the sleeves is angled and arranged in a particular position relative to the bar that attaches to the trailer hitch.

The present invention offers users a handy work platform, and the present invention easily slides into a truck mounted trailer hitch. The present invention goes beyond a typical platform to which tools attach via a vise, as the present invention can serve as a mount for a barbecue for camping, a telescope, or any other item. The top plate of the present invention can be replaced with a barbecue, a telescope, or any other device that can interface with the present invention.

With the ability to raise to three different heights, preferably, the present invention is able to provide a low height posture that is close to the vehicle to which it is attached; a middle height posture that is somewhat distanced from the vehicle to which it is attached; and a high height posture that is even farther distanced from the vehicle to which it is attached. The present invention is suitable for a variety of applications because of its great positional flexibility, such that construction, plumbing, electrical, and automotive work can be done accomplished with the present invention as easily as a tailgating party at a football game.

A first member of the present invention attaches to a conventional trailer hitch of a vehicle. The first member has two conventional holes to attach to a conventional trailer hitch. The first member is held in a relatively horizontal position. A second member of the present invention is fixedly held in relation to the first member, and the second member depends from the first member at an approximate 135 degree angle. The second member acts as a sleeve into which a first end of a third member fits. The third member engages the second member in preferably three positions, each of the positions corresponding to different lengths of the first end of the third member that slide into the second member. A second end of the third member is removably attached to a first plate. Preferably, users can remove the first plate from the third member, and place various other items (such as barbecues, telescopes, or any other device for attachment) atop the third member.

In alternative embodiments, several second plates can be attached to a barbecue, for example, while another of the second plates can be attached to a cutting machine. In use, the second plates can be quickly and easily attached to the first plate. In short, each second plate becomes a base for each of a device for attachment. Thus, rather than the user having to bother with attaching devices to the second plates each time use of the devices is desired; the user merely attaches a device to a second plate once. Then, the user can attach and detach second plates quickly and easily depending on the device desired for use.

Preferably, the present invention uses simple hand-operation to adjust the height of the first plate. Pins placed through holes, or any other conventional means of maintaining two pieces together in a fixed position can be employed to control how far the third member extends from the second member. Further, there is little chance of the present invention moving in any direction but being able to adjust along one axis. This adds to the overall strength of the present invention.

The present invention does not require any point of attachment but to a convention trailer hitch. Thus, it is very versatile and adaptable to many vehicles on the market and/or owned already. Preferably, there are not any pistons or other heavy, costly, complicated, or serviceable items but for that which has been described.

Unlike other inventions, the present invention provides a unique arrangement of elongated attachment members in combination with plates. Further, the plate(s) and their interaction with one another and other devices is unique. Moreover, there is not a lightweight device with an arrangement to avoid movement but vertically, that is also sturdy and able to handle weight tolerances of barbecues, telescopes, and other devices placed atop.

### BRIEF DESCRIPTION OF THE DRAWINGS

FIG. 1 shows a left side view of the present invention.

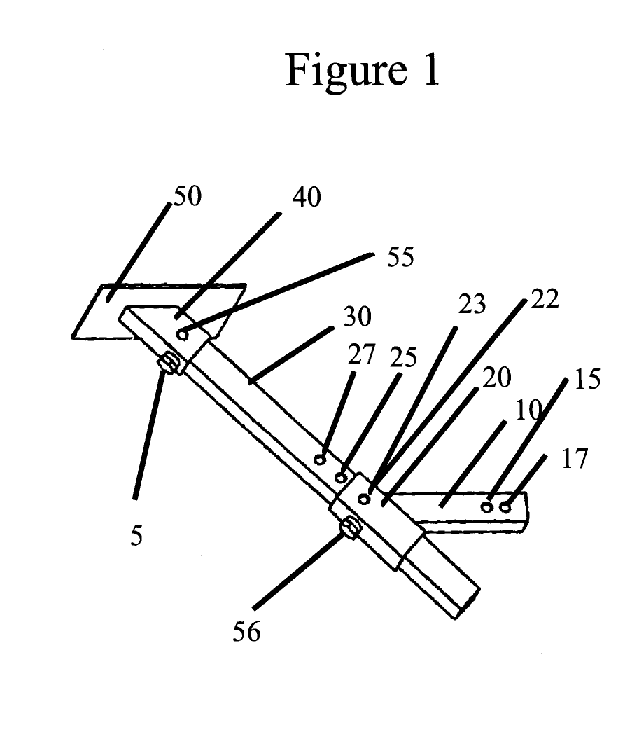

FIG. 2 shows a right side view of the present invention.

### DETAILED DESCRIPTION OF THE PREFERRED EMBODIMENT(S)

A first member of the present invention (10) attaches to a conventional trailer hitch of a vehicle. Conventional pins for securing devices to trailer hitches should be used with the present invention to secure it to a conventional trailer hitch. All measurements provided below are in inches. First member (10) is preferably a hollow aluminum structure and preferably measures 2×2×0.25. The first member (10) has two predrilled holes (15 and 17), which can attach to the conventional trailer hitch of a vehicle. The first member (10) is held in a relatively horizontal position. A third member (30) of the present invention is fixedly held in relation to the first member (10), and the third member (30) depends from the first member (10) at an approximate 135 degree angle. The third member (30) has the same dimensions as the first member (10), 2×2×0.25 and is also composed of hollow aluminum. The second member (20) acts as a sleeve into which a first end of a third member (30) fits. The second member (20) has dimensions of 2.5×2.5×0.25.

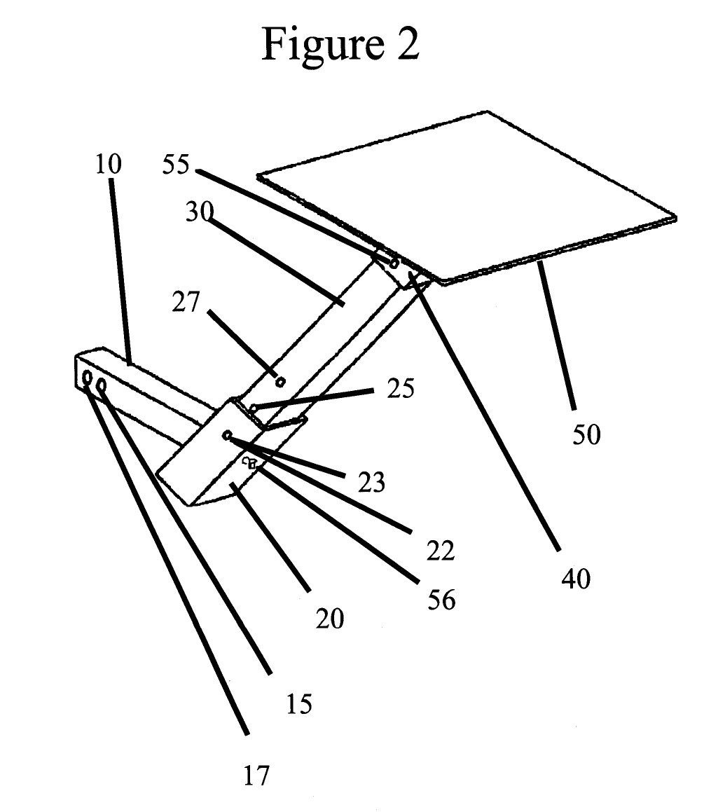

The third member (30) engages the second member (20) in one of a possible three positions, each of the positions corresponding to different lengths of the first end of the third member (30) that slide into the second member (20). The first end of the third member (30) extends through the second member (20). The length of this extension depends on which predrilled holes (23,25,27) is lined up with and secured to the second member (20). In FIG. 2, predrilled hole (23) is shown lined up with second member (20), such that second member (20) has a hole (22) that is lined up with predrilled hole (23) of third member (30). The predrilled holes (23,25,27) will allow for more or less distance between the trailer hitch and the vehicle, depending on which predrilled hole is selected. The highest predrilled hole (27) provides the least distance, the middle hole (25) provides the mid distance, and the lowest hole (23) provides the most distance between first plate (50) and first member (10), when lined up with hole (22) of second member (20).

A second end of third member (30) is fixedly or removably attached to a first plate (50). First plate (50) preferably measures 19×11×0.25. Optionally, first plate (50) can contain grooves that firmly attach to a removable second plate of any configuration. The first plate (50) is attached to the second member (20) by an aluminum sleeve (40). This aluminum sleeve (40) measures 2.5×2.5 and is not adjustable as it only contains one hole (55). Aluminum sleeve (40) is fixedly attached and/or welded to first plate (50), and then aluminum sleeve (40) is attached to second end of third member (30). The sleeve (40) is easily detached from the second end of the third member (30), thus allowing a wide variety of attachments to be secured to the third member (30). This design allows for a wide range of usage while utilizing a strong, yet inexpensive design. For example, if sleeve (40) is fixedly attached to first plate (50), then sleeve (40) and first plate (50) are removed together from third member (30) and any other device attached to another sleeve (40) could be attached to third member (30) via another sleeve (40).

Reinforcers (5) and (56) can be any typical connection, such as thumbscrews or bolts, to provide a different axis of tightening to ensure that sleeve (40) and second member (20) do not lose grip and allow third member (30) to move within sleeve (40) and second member (20).

It should be noted that various devices can be attached to third member (30) in place of first plate (50). Such devices, such as a combination bicycle/snow board/ski rack could be attached to third member (30) so long as they would have sleeve (40) to provide secure and simple attachment as aforementioned.

The present invention is not solely limited to the embodiments aforementioned, but is any and all embodiments with in the scope of the following claims.

1. An attachment for a vehicle, comprising:
a first member;
a second member, disposed at an angle away from said first member;
a third member, disposed partially within said second member; and
a fourth member, disposed atop said third member.

2. The attachment of claim 1, wherein said first member is hollow.

3. The attachment of claim 1, wherein said second member is hollow.

4. The attachment of claim 1, wherein said third member is hollow.

5. The attachment of claim 1, wherein said fourth member is a plate.

6. The attachment of claim 1, wherein said second member is disposed at a 135 degree angle from said first member.

7. The attachment of claim 1, wherein said fourth member is disposed at a 45 degree angle from said third member.

8. The attachment of claim 1, wherein
said first member is hollow;
said second member is hollow;
said third member is hollow;
said fourth member is a plate;
said second member is disposed at a 135 degree angle from said first member; and
said fourth member is disposed at a 45 degree angle from said third member.

9. The attachment of claim 1, wherein said third member is adjustable within said second member so as to vary the height of said fourth member.

10. The attachment of claim 8, wherein said third member is adjustable within said second member so as to vary the height of said fourth member.
